(19) United States
(12) Patent Application Publication
(10) Pub. No.: US 2008/0120255 A1
(43) Pub. Date: May 22, 2008

(54) Water supply insurance method

(76) Inventor: Tyran Adams, Omaha, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/975,863

(22) Filed: Oct. 22, 2007

Related U.S. Application Data
(63) Continuation-in-part of application No. 10/286,188, filed on Nov. 1, 2002, now abandoned.

(51) Int. Cl. G06Q 90/00

(52) U.S. Cl. 705/412

(57) ABSTRACT

A water supply insurance method for providing an emergency water supply in a severe water shortage includes the steps of securing water rights to a water source and initiating discussion with a water-using client for issuing of a water supply insurance policy, including information pertaining to expected water needs, term of insurance and cost of water supplied. An insurance rate for the water-using client is calculated based the information and premiums are collected. When the normal water supply is significantly interrupted, emergency water is provided in the amount specified in the water supply insurance policy until the crisis is over, and then collection of premium payments from the water-using client is resumed to ensure future supply of emergency water so long as the water supply insurance policy remains in force.

### CROSS-REFERENCE TO RELATED APPLICATION

This continuation-in-part application claims priority to the filing date of related patent application Ser. No. 10/286,188 filed on Nov. b 1, 2002.

### BACKGROUND OF THE INVENTION

1. Technical Field

The present invention relates to water insurance methods and, more particularly, to an insurance method in which the water insurance provider would initiate discussion with a water-using client regarding water needs, calculate an insurance rate with the water-using client based on expected emergency use and water cost, collect premiums from the water-using client until such time as an emergency water shortage occurs, at which time the insurance provider would arrange for delivery of water to the water-using client on an emergency basis, thereby securing water rights for the water-using client in the event of an emergency.

2. Description of the Prior Art

It is a well-known fact that the world will soon be facing major deficits in the amount of fresh water available for growing crops, processing materials, and, most importantly, for eating and drinking. In fact, it is prophesied by some agencies that two out of three people in the world will face water shortages by the year 2025. Reduced consumption and modification of materials processing methods may save some of the water needed for the basic needs of people, but such changes are designed to alleviate the long-term, statistically-averaged water consumption plight which will be faced by the citizens of the world. The real question is, however, how facilities requiring water for the persons housed therein will manage to survive severe drought conditions or other such short-term water shortage situations. Chief among these facilities would be such locations as hospitals, nursing homes, and other such locations in which a large number of movement-restricted people are housed. In the event of a water emergency, it can become difficult or even impossible to supply water for the basic needs of the residents of these facilities, and, at present, there is no method or system in place to do so. There is therefore a need for an emergency water supply method which is instigated in the event of a water shortage crisis.

With advanced planning it can be relatively easy to insure an adequate supply of water for such facilities, provided that a water source is guaranteed through a mechanism such as insurance payments. In fact, it may be beneficial for such facilities to pay an insurance premium to a company to guarantee that emergency water will be available in the event of a severe water shortage. In this case, the facility would pay the insurance premium and the insurance provider would guarantee that a predetermined amount of water per person per day would be available from a fresh water source obtained by the insurance provider or an agent thereof in order to insure the continued supply of fresh water to the facility. At the present time, there is no such method by which access to a fresh-water supply may be insured, and therefore there is a need for such a method and system.

Therefore, an object of the present invention is to provide a water supply insurance method and system for insuring an emergency fresh water supply to a facility such as a hospital, nursing home, or other such facility.

Another object of the present invention is to provide a water supply insurance method and system in which discussions would be initiated with a water-using client regarding water needs, and an insurance rate would be calculated for the water-using client based on the expected water needs and the agreed-upon price for the water.

Another object of the present invention is to provide a water insurance method and system in which premiums would be paid by the water-using client until such time as a severe water shortage occurs thus requiring supply of the emergency water source.

Another object of the present invention is to provide a water supply insurance method and system in which, in the event of an extreme water shortage, the pre-arranged water delivery will take place, thus insuring an emergency water supply for the water-using client, with the insurer or his agent arranging for the priority access to the fresh water supply in exchange for the insurance policy.

Another object of the present invention is to provide a water supply insurance method and system in which the water supply is delivered to the water-using client via a tanker truck or the like, thus providing a portable source of potable water.

Finally, an object of the present invention is to provide a water supply insurance method and system which will insure an emergency supply of fresh water for future emergency needs.

### SUMMARY OF THE INVENTION

The present invention provides a water supply insurance method and system in which an emergency water supply is deliverable to an insured water-using client. The method includes the steps of securing water rights to a fresh water source and initiating discussion with a water-using client regarding water needs. The insurance rate for the water-using client would then be calculated based on those water needs and the expected water cost and collection of the premiums from the water-using client would commence. In the event of interruption of normal water supply to the water-using client, the insurer commences providing emergency fresh water in the amount specified in the insurance policy for the one of the entire period set forth therein or until such time as the normal water supply is resumed. Resumption of premium payments by the water-using client ensures future supply of emergency water so long as the insurance policy remains in force.

The water supply insurance method and system of the present invention thus provides a substantial improvement over those methods found in the prior art. For example, in the event of a severe water shortage, it may be impossible for a water-using entity to obtain sufficient fresh water without having pre-existing rights to the water. Furthermore, the last thing that a hospital or other such institution needs to be concerned with is a lack of water, particularly when disruption of water supply may be accompanied by other significant disruptions in the everyday routine which could result in increased usage of hospital facilities. Finally, as there is currently no method or system in place by which a facility can insure itself to obtain a source of water in an emergency, it would appear that the present invention addresses and solves a long-felt and unsolved need. Also, the present invention will prevent additional loss of life due to the unavailability of an emergency water source. It is thus seen that the water supply insurance method and system of the present invention is superior and in fact unique when compared to those methods found in the prior art.

### BRIEF DESCRIPTION OF THE DRAWINGS

FIG. 1 is a flowchart showing the water supply insurance method and system of the present invention.

### DESCRIPTION OF THE PREFERRED EMBODIMENT

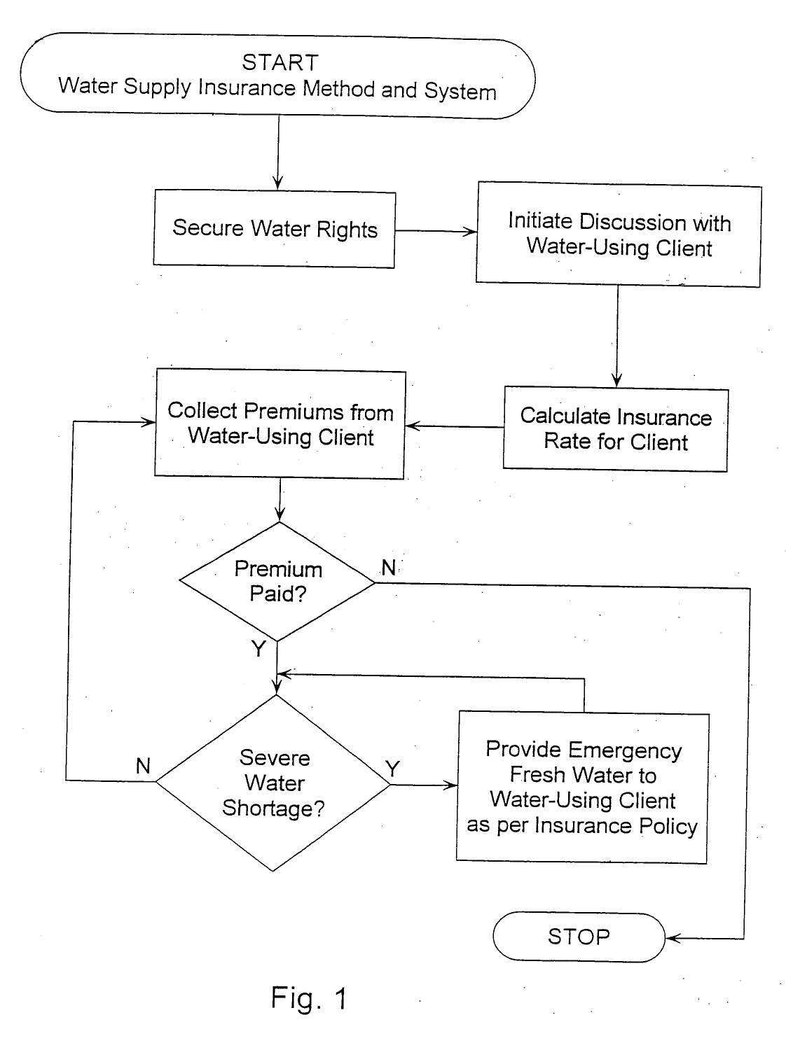

The water supply insurance method and system of the present invention is shown flow chart form in FIG. 1 and includes the following steps. The insurance provider would initiate the method of the present invention by obtaining and securing water rights to a fresh water source, either potable or non-potable, which will be available even in times of severe water shortages caused by drought, contamination, or other such natural or man-made disasters. The attaining of these water rights may be done directly by the insurance provider or through an agent or other such source so long as the superior water rights are retained. Generally, what is meant by obtaining water rights is that the insurance provider will obtain a generally uninterruptible water right for a predetermined period of time (renewable yearly, five year or ten year contract, etc.), and the water rights obtained will permit a certain amount of water to be withdrawn over a certain period of time. It is important to note that these water rights are obtained by the insurer only, and the potential water-using clients are in no way involved in the obtaining or purchasing of these water rights. After these water rights are obtained, the insurance provider would then begin discussions with water-using clients for the sale of the water supply insurance.

During the discussions between the water-using client and the insurance provider, basic information will be exchanged, such as the amount of water needed on a daily basis by the water-using client, the desired point at which the supplemental emergency water would become available due to a severe water shortage, and other such information which would permit the formulation of the water supply insurance policy specifically tailored to the water-using client and its needs. Chief among this information is exactly what will constitute a significant interruption of water supply for each client, as each client will have different needs in terms of water supply for their business or facility. For example, a factory which uses water for cooling in their processing procedures will face severe disruptions in their operations almost as soon as the interruption to their water supply occurs, whereas other types of businesses and facilities will encounter a significant interruption of water supply under different circumstances. For purposes of this disclosure, however, a significant disruption of water supply for the water-using client shall mean any disruption which reduces the normal operation of the business or facility of the water-using client by more than fifty percent (50%), although this may be modified or changed by mutual agreement between the insurer and the water-using client. In fact, for situations involving providing potable water, the constitution of a significant interruption or disruption of the water supply will likely be far more quickly realized, as any lack of water for drinking and cleaning may be deemed significant. However, the insurer and water-using client will mutually decide what constitutes a significant disruption in water supply, and therefore each situation will likely be determined on a case-by-case basis.

Once the specific details of the water supply insurance policy are formulated, the insurance provider would compute a premium amount payable by the water-using client on a monthly, quarterly, semi-annual or annual basis, which would take into account the expected water supply amount, cost for the water, and cost for the delivery of the water, with the likelihood of the severe water shortage conditions arising being calculated in order to arrive at the specific dollar amount for the premium to be paid. Other such details to be included in the water supply insurance policy would be the term of the policy, the deductible, any co-payments due after expiration of the deductible, and renewal terms, similar to many types of insurance policies currently found in the prior art. Once all of the terms of the contract are determined, the water-using client would commence payment of the premiums and the insurance provider would issue the water supply insurance policy to the policyholder.

In general, the premium would be calculated by the following formula:

Premium=Σn (Pᵣₜ) (Costₜ) (dₜ) or

Premium=Pr1*cost1*d1 +Pr2*cost2*d2+Pr3*cost3*d3

where
n=contract period (monthly premium)
Cost=(water cost)*(gallons needed)+truck rental+labor+fuel+retainer fees)+charge for water into the future
Pr=probability
Probability=likelihood of significant interruption (the higher the likelihood the higher the factor)
d=discount factor−time value of money=(1ₜᵢ)−t

As an example of the calculations used in connection with the present method, presuppose a small coastal community of approximately 3,000 people which enters into an insurance agreement with an insurance provider utilizing the method of the present invention. In the event of a significant interruption of water supply to the town for a period of three days, which represents the average length of time of a significant disruption, the town will require 18,000 gallons of water, with each person requiring approximately two gallons per day for the three day period. The cost for the water will be $0.05 per gallon, and therefore the expected water cost will be $0.05 times 18,000=$900.00. To deliver the water to the town, two trucks will be rented, at a cost of $9,000.00, and labor costs for the delivery of the water will equal approximately $6,500.00, including truckers, loaders and supervisors. Fuel costs at $3/gallon would equal approximately $1,500.00, retainer fees would equal approximately $2,000 and miscellaneous costs would be approximately $100.00. Therefore, the total expected cost for the three day supply of emergency water would be $900.00+$9,000.00+$6,500.00+$1,500.00+$2,000.00+$100.00=$20,000.00, and the costs may be expected to increase approximately three percent (3%) per year.

Once the expected costs are calculated by the insurer, a premium can be calculated once the probability of significant disruption is calculated. Obviously, each water-using client will have slightly different probabilities of significant disruption, but a reasonable approximation of the probability can be determined by examining factors which will likely cause water disruption. Specifically, in the above example, a coastal community will most likely have a disruption due to a weather-related situation, most likely a hurricane, and the probability of a serious hurricane strike on the community is obtainable via the National Hurricane Center. Likewise, other occurrences which can result in significant disruption of water supply also can be determined and probabilities and risks determined for those occurrences, and such probabilities are available via other similar sources which focus on such occurrences.

For example, the probability of a hurricane strike on the coastal community may be once every 75 years, which would work out to an average of once in every 900 months. Therefore, factoring in a profit margin on the premium to be paid by the community, and knowing that the expected costs will be $20,000.00, we calculate the cost of the premium as follows:

First Year Premium

(0.001111)*(20,000)*(0.85)*(1.40)*(12) $317.30

Hurricane probability*Cost*Present Value of Money*Profit*12 months

The first year premium would thus be $317.30, and the second, third, fourth and so on year premiums would be higher due to inflation and possibly to an increase in the probability of the hurricane or other factors which will be determined.

It is important to note that the premium will be paid to the insurer regardless of whether water is ever needed, exactly as is found in health insurance, life insurance and other types of insurance agreements. Moreover, the water-using client will likely not pay any monies beyond the premiums should water delivery be required, and therefore the present method is a method of providing insurance for an insuree as the water-using client has no involvement in obtaining the water rights, obtaining delivery of the water or any other aspect of the present method save getting their water delivered to them in the event of significant disruption of their water supply.

By way of further example, the water-using client in the description of the preferred embodiment of the present invention will be a hospital, although it is to be understood that virtually any type of business, group of persons or individuals may be potential clients of the present invention, including small towns, villages, etc. To illustrate the way in which the water supply insurance method and system of the present invention would be implemented, let us move forward in time to a point where a severe water shortage has caused the normal water supply of the water-using client, in this case the hospital, to become unavailable for use, thus requiring the supplementation of the water supply via the water supply insurance policy. It is expected that the standard water supply insurance policy issued by the present method would include terms such as a guaranteed seven-day emergency supply of water in a predetermined amount with additional water supply available after the expiration of the initial seven-day period for a significant co-pay amount. It should be noted that the specific amount of water provided under the policy will be determined on a case-by-case basis, but, in the event of hospital usage of water, it is expected that somewhere between thirty and sixty gallons of water per person per seven days would be sufficient to insure continued operation of the hospital and would provide sufficient water for patients and staff to “ride out” the severe water shortage. The amount of water that will be provided per day will depend upon numerous factors such as the amount of water needed for hygiene purposes, dialysis, cooking, drinking, bathing, and so on, although many of these uses are not strictly necessary for survival and thus water consumption may be further reduced. Once the insurance provider is contacted by the hospital regarding implementation of the water supply insurance policy, the insurance provider would initiate delivery of fresh water from the specifically reserved water source. Delivery of the water from the water source to the hospital would be by various means, although it is expected that a food grade tanker truck would be used, one which is certified and includes a transfer pump which would permit transfer of the potable water from the tanker truck to the supply system of the hospital. A standard tanker truck would carry approximately 6,250 gallons of water which would be sufficient to provide between 500 and 1500 people with their water needs for a day in the above-described situation. The tanker truck would then return daily to the water source and replenish the water in the storage tank, then return to the hospital for further delivery of water until such time as the severe water shortage is ended. Of course, it should be noted that other water delivery methods, such as smaller delivery tanks and vehicles, may be used with the present invention so long as the intended purpose of quickly and efficiently providing emergency water to a water-using client is fulfilled.

Depending on the specific terms of the water supply insurance policy issued under the method of the present invention, the water-using client would be assured of an emergency supply of water for the term agreed upon, be it seven days, fourteen days, or a greater length of time. According to various accepted insurance practices, the delivery of the emergency water may be free of charge for the agreed upon term if the policy states such, or the policy may include such a term as an 80/20 co-pay, with the hospital paying twenty percent of the water cost up to an agreed-upon deductible. Once the deductible is met, additional emergency water would be supplied under the water supply insurance policy with costs being paid by the insurance provider. In this manner, the water-using client may receive emergency water through the policy for as long as the severe water shortage occurs and, like the majority of insurance policies currently issued, once the deductible is met for the year, no further payments of the deductible are expected under the policy. It is further expected that other policy terms may be included, such as an overall cap on the amount of water which may be procured under the policy by the water-using client, the maximum length of supply in days due under the policy, and other such terms which may be mutually agreed to between the insurance provider and the water-using client. Likewise, the insurance policy will stay in effect for as long as the two parties agree to the terms of the policy and so long as the insurance premiums are paid.

It is to be noted that numerous additions, modifications, and substitutions may be made to the water supply insurance method and system of the present invention which fall within the intended broad scope of the appended claims. For example, the specific terms, amounts, and other details of the policies issued will be determined on a case-by-case basis depending upon the specific needs of the water-using client. Furthermore, the specific water supply source which is secured by the insurance provider may be of any appropriate kind of water source so long as the water source is guaranteed to be available even during conditions of extreme drought, contamination, or other such disaster. Also, the specific policy nature, be it term water insurance, whole water insurance, or other such details, will be determined by the insurance provider based on a review of the water-using client's situation and expected policy usage. Furthermore, the water being supplied by the method of the present invention need not be potable or even be fresh water depending on the intended use of the water, rather it is only intended that emergency water be provided to the water-using client for whatever purposes they will use it. Finally, it is important to note that, although there are numerous types of insurance currently available, specifically providing an uninterruptible emergency water source to institutions and small towns including hospitals, old-age homes, and other such care providing facilities is not known in the prior art, particularly in connection with an insurance policy guaranteeing access to the water supply in the event of a severe water shortage.

There has therefore been shown and described a water supply insurance method and system which accomplishes at least all of its intended objectives.

1. A water supply insurance method for providing an emergency water supply in a severe water shortage comprising the steps:
securing generally uninterruptible water rights to at least one water source by an insurer for a predetermined time period to obtain a predetermined amount of water during a predetermined water supply time period;
discussing with a water-using client its water needs for issuing of a water supply insurance policy, including information pertaining to expected water needs, term of insurance and cost of water supplied;
determining probability and risk of significant interruption of water supply to said water-using client;
calculating an insurance rate for said water-using client based said information and said probability and risk of significant interruption of water supply;
creating an insurance contract and agreement setting forth the terms of the water supply insurance policy;
collecting premiums from said water-using client for implementation of said water supply insurance policy;
providing emergency water in the amount specified in said water supply insurance policy in the event of significant interruption of normal water supply to said water-using client for one of the entire supply period stated in said water supply insurance policy and the time normal water supply is resumed to said water-using client;
said water-using client obtaining no water rights to said water source, only rights to delivery of emergency water via said insurer;
stopping the collection of premium payments during said step of providing emergency water to said water-using client; and
resuming collection of premium payments from said water-using client thereby ensuring future supply of emergency water so long as said water supply insurance policy remains in force.

2. The water supply insurance method of claim 1 wherein said step of securing water rights includes securing generally uninterruptible rights to a fresh water source.

3. The water supply insurance method of claim 1 wherein said step of securing water rights includes securing generally uninterruptible rights to at least one of a non-potable, potable and treated water source.

4. The water supply insurance method of claim 1 wherein said step of initiating discussion with a water-using client further includes obtaining information regarding expected water supply amount needed, cost for the water, cost for the delivery of the water and the likelihood of severe water shortage conditions arising during the term of the insurance policy.

5. The water supply insurance method of claim 4 wherein said step of calculating an insurance rate for said water-using client further includes review of the expected water supply amount, cost for the water, cost for the delivery of the water and the likelihood of severe water shortage conditions arising during the term of the insurance policy being calculated in order to arrive at the specific dollar amount for the premium to be paid, said water supply insurance policy further including the term of the policy, the deductible, any co-payments due after expiration of the deductible and renewal terms.

6. The water supply insurance method of claim 1 wherein said step of providing emergency water to said water-using client further comprises initiating delivery of said emergency water from said water source via a food grade tanker truck including a transfer pump which would permit transfer of the emergency water from said tanker truck to the supply system of the water-using client.
